(19) United States
(12) Patent Application Publication
(10) Pub. No.: US 2010/0260023 A1
(43) Pub. Date: Oct. 14, 2010

(54) VIRTUAL SPOKE SIGNALS FOR CONTROLLING OPTICAL DISC

(76) Inventors: Matthew J. Janssen, Corvallis, OR (US); Timothy Wagner, Corvallis, OR (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/741,654

(22) PCT Filed: Nov. 24, 2007
(86) PCT No.: PCT/US07/85478

§ 371 Date: May 6, 2010

(51) Int. Cl. G11B 19/00

(52) U.S. Cl. 369/47.38; G9B/19

(57) ABSTRACT

An optical disc is rotated at no more than 600 revolutions per minute (RPM) using a spindle motor of an optical disc device (602). One or more input signals are received from one or more sensors disposed within the optical disc device (604). The sensors are responsive to rotation of the optical disc. Virtual spoke signals are generated based on the input signals received from the sensors (606). The optical disc is positionally controlled based on the virtual spoke signals generated, as the optical disc rotates at no more than 600 RPM (612). The virtual spoke signals correspond to actual, physical spokes that would otherwise have to be present on the optical disc to positionally control the optical disc as the optical disc rotates at no more than 600 RPM.

### BACKGROUND

Some types of optical discs permit end users to optically write data on optically writable data surfaces of the optical discs. For example, users may be able to store data on the optical discs for later retrieval. Such data may include computer files, images, music, and other types of data. However, historically, users have had to label the optical discs using markers, which yields unprofessional results, or affix labels to the label sides of the optical discs, which can be laborious.

More recently, users have been able to form images directly on the label sides of optical discs, using optical discs that have optically writable label surfaces. The users employ optical disc devices that are able to optically write to such label surfaces of optical discs. For example, the previously filed patent application entitled “Integrated CD/DVD Recording and Label” [attorney docket 10011728-1], filed on Oct. 11, 2001, assigned Ser. No. 09/976,877, and published as US published patent application no. 2003/0108708, describes an optical disc having such an optically writable label surface.

Some types of optical discs having optically writable label surfaces have preformed or pre-imaged encoder spokes on areas of the optical discs. While such an optical disc is being rotated, the encoder spokes are detected so that the relative angular position of the optical disc currently incident to an optical mechanism that forms an image on the optically writable label surface of the optical disc is known. Employing encoder spokes to positionally control an optical disc while optically writing to the optically writable label surface of the optical disc can be disadvantageous, however.

The encoder spokes may not be able to be detected properly, due to the encoder spokes improperly interacting with other aspects of the optical discs. In some cases, forming the encoder spokes on optical discs raises the manufacturing costs of these optical discs. Detecting the encoder spokes can also require optical disc devices to have encoders and other hardware just for this purpose, raising their manufacturing costs as well. The encoder spokes further occupy relatively scarce space on optical discs that could otherwise be used for other purposes.

### BRIEF DESCRIPTION OF THE DRAWINGS

FIG. 1 is a diagram of an optical disc having an optically writable label surface and a control feature area, according to an embodiment of the present disclosure.

FIG. 2 is a diagram of the control feature area of an optical disc in detail, according to the prior art.

FIG. 3 is a front view diagram of an optical disc device, according to an embodiment of the present disclosure.

FIG. 4 is a top view diagram of a portion of the optical disc device of FIG. 3, according to an embodiment of the present disclosure.

FIG. 5 is a diagram of a plot of input signals generated by sensors of an optical disc device, such as Hall effect sensors, as the spindle of the optical disc device rotates, according to an embodiment of the present disclosure.

FIG. 6 is a flowchart of a method for positionally controlling an optical disc based on generated virtual spoke signals, as the optical disc is rotated at low speed, according to an embodiment of the present disclosure. Positionally controls herein means that, for instance, the angular position and/or the angular speed of the optical disc as it rotates is controlled.

FIG. 7 is a diagram of a look-up table that can be employed to generate virtual spoke signals on the basis of input signals generated by sensors of an optical disc device, according to an embodiment of the present disclosure.

FIG. 8 is a diagram of a triangle wave linear approximation of the input signals generated by sensors of an optical disc device, between crossover points of the input signals, and which can be employed to generate virtual spoke signals, according to an embodiment of the present disclosure.

FIGS. 9A, 9B, and 9C are diagrams exemplarily depicting how a reference signal having virtual spokes a priori mapped thereon can be employed in relation to one of the input signals generated by sensors of an optical disc device to generate virtual spoke signals, according to an embodiment of the present disclosure.

### DETAILED DESCRIPTION OF THE DRAWINGS

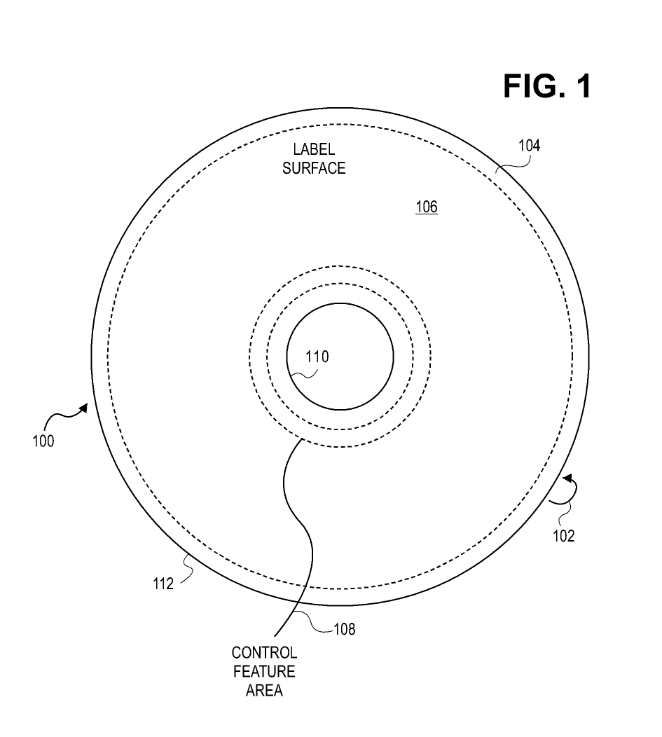

FIG. 1 shows an optical disc 100, in relation to which embodiments of the present disclosure can be practiced. The optical disc 100 includes an optically writable data side 102, which is the side that is not shown in FIG. 1, and an optically writable label side 104, which is the side that is shown in FIG. 1. The optical disc 100 includes an inside edge 110 and an outside edge 112. The optically writable label side 104 includes an optically writable label surface 106 and can also include a control feature area 108, the latter being close to the inside edge 110 in the embodiment of FIG. 1.

The optically writable data side 102 of the optical disc 100 includes a data region on which data may be optically written to and/or optically read by the optical disc device. The data side 102 is thus the side of the optical disc 100 to which binary data readable by the optical disc device and understandable by a computing device is written, and can be written by the optical disc device itself. For instance, the data side 102 may be the data side of a compact disc (CD), a CD-readable (CD-R), which can be optically written to once, a CD-readable/writable (CD-RW), which can be optically written to multiple times, and so on.

The data side 102 may further be the data side of a digital versatile disc (DVD), a DVD-recordable (DVD-R or DVD+R), a DVD that is recordable and writable (DVD-RW or DVD+RW), a DVD-RAM, or a dual-layer recordable DVD, among other types of optical discs. The data side 102 may also be the data side of a high-capacity optical disc, such as a Blu-ray optical disc, a High Definition HD-DVD optical disc, and so on.

The label side 104 is the side of the optical disc 100 to which visible markings can be optically written on the optically writable label surface area 106 thereof to realize a desired label image. For instance, the label side 104 may be part of an optical disc that is described in the previously filed patent application published as US published patent application no. 2003/0108708, which describes an optically writable label side of an optical disc. It is noted that in other embodiments at least one of the sides 102 and 104 of the optical disc 100 may have both label regions and data regions.

The control feature area 108 when present can include features that describe the optically writable label surface 106 of the optical disc 100, and/or that are used during image formation on the label surface 106 to properly form a desired image on the label surface 106. The control feature area 108 may thus include features to calibrate an optical mechanism of the optical disc device in which the optical disc 100 has been inserted, for optimal image formation on the label surface 106. The control feature area 108 may include a media identification pattern indicating the type of the label surface 106, information regarding which is then used for optimal image formation on the label surface 106. The control feature area 108 may further include encoder spokes as well as other features. However, embodiments of the present disclosure eliminate the need for such actual, physical encoder spokes being present within the control feature area 108.

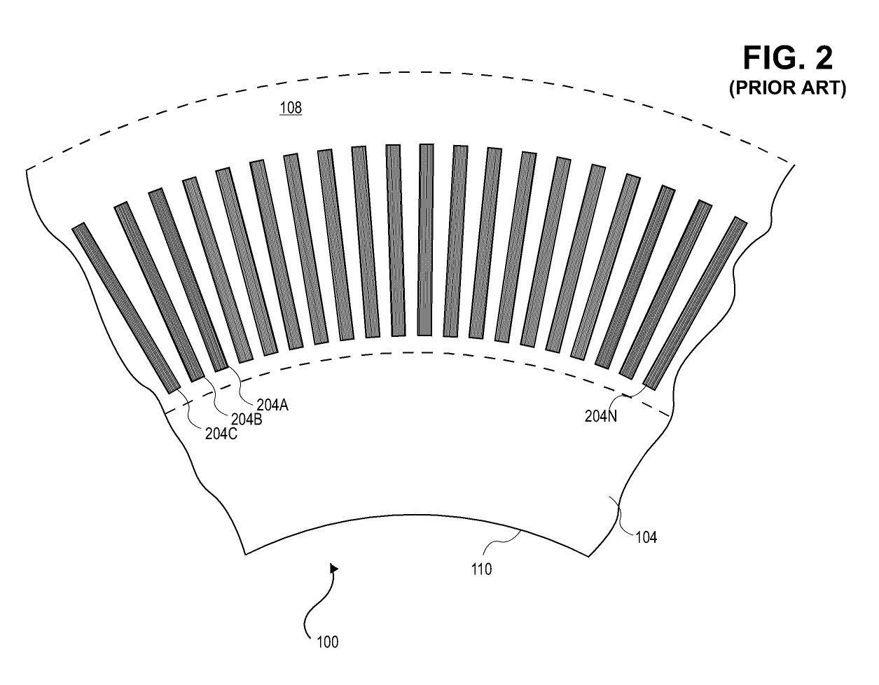

FIG. 2 shows a portion of the control feature area 108 of the label side 104 of the optical disc 100 in detail, according to the prior art. The control feature area 108 is depicted in FIG. 2 as including a number of encoder spokes 204A, 204B, 204C, . . . , 204N, collectively referred to as the encoder spokes 204. The control feature area 108 may include other features, in addition to and/or in lieu of the encoder spokes 204, such as index marks, calibration features, media identification patterns, and so on, as can be appreciated by those of ordinary skill within the art.

The encoder spokes 204 are actual, physical equally spaced rectangular marks around the circumference of the control feature area 108 viewable from the label side 104 of the optical disc 100. For instance, there may be 400 of such encoder spokes 204. The encoder spokes 204 are ordinarily and normally detected by an encoder of the optical disc device that may be permanently positioned incident to the control feature area 108, while the optical disc 100 is being rotated within the optical disc device 100. By detection of the encoder spokes 204, the optical disc device detects how much the optical disc 100 has angularly moved. As such, the current angular position of the optical disc 100 is known, so that an image is properly formed on the optically writable label surface 106 on the label side 104 of the optical disc 100.

However, as has been described in the background section, using actual, physical encoder spokes 204 to detect the current angular position of the optical disc 100 can be disadvantageous. Therefore, embodiments of the present disclosure instead generate virtual spoke signals that correspond to these encoder spokes 204 that would otherwise have to be present on the optical disc 100 to positionally control the optical disc 100 as the optical disc 100 rotates. That is, embodiments of the present disclosure eliminate the need for the actual, physical encoder spokes 204 having to be present on the optical disc 100 while still being able to positionally control the optical disc 100 as the optical disc 100 is rotated.

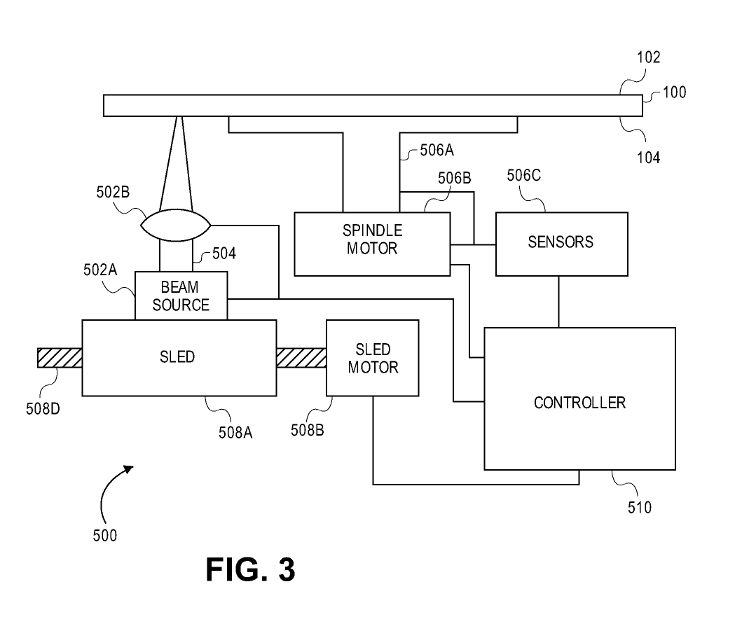

FIG. 3 shows a front view of an optical disc device 500, according to an embodiment of the present disclosure. The optical disc device 500 is for reading from and/or writing to the optical disc 100 inserted into the optical disc device 500 and that has been described. The optical disc device 500 includes a beam source 502A and an objective lens 502B, which are collectively referred to as the optical mechanism 502. For exemplary purposes only, the optically writable label side 104 of the optical disc 100 is depicted as being incident to the optical mechanism 502 in FIG. 3, such that the optical disc device 500 is or is about to optically write an image to the label side 104.

The optical disc device 500 also includes a spindle 506A, a spindle motor 506B, and one or more sensors 506C, which are collectively referred to as the first motor mechanism 506. It is noted that in at least some embodiments, the optical disc device 500 includes an encoder, such as an optical encoder, to specifically detect the encoder spokes 204 on the control feature area 108, and thus to specifically determine the current angular position of the optical disc 100 as incident to the optical mechanism 502. Such an encoder, for instance, may include an optical emitter/optical receiver pair to detect the encoder spokes.

Rather, in these embodiments, the sensors 506C are used to specially determine the current angular position of the optical disc 100, and thus can be used to positionally control the optical disc 100. The sensors 506C may be Hall effect sensors, for instance, as can be appreciated by those of ordinary skill within the art. The sensors 506C are ordinarily and normally disposed within the optical disc device 500 to control the optical disc 100 as the optical disc rotates at speed no less than 800 revolutions per minute (RPM).

That is, where the optical disc device 500 is capable of just optically writing to and/or reading from the optically writable data side 102 of the optical disc 100—and not necessarily, for instance, to and from the optically writable label side 104 of the optical disc 100—the optical disc device 500 normally and ordinarily includes the sensors 506C to provide feedback to positionally control the optical disc 100 as it rotates at speeds no less than 800 RPM for current optical disc devices and likely for future optical disc devices as well. However, these sensors 506C do not have enough precision to provide feedback to positionally control the optical disc 100 as it rotates at speeds no greater than 600 RPM, as can be required to optically write to the optically writable label side 104 of the optical disc 100. As such, embodiments of the present disclosure leverage the sensors 506C that are already present within the optical disc device 500 to positionally control the optical disc 100 as it rotates at no less than 800 RPM, to also use the sensors 506C to generate appropriate feedback to positionally control the optical disc 100 as it rotates at no more than 600 RPM.

Stated another way, in other words, the sensors 506C are present within ordinary optical disc devices to positionally control the optical disc 100 as the optical disc 100 rotates at high speeds, which are defined herein as being no less than 800 RPM, and typically as high as 10,000 RPM, which corresponds to the speed at which a 52× optical disc device rotates the optical disc 100. As such, within the prior art, to also positionally control the optical disc 100 as the optical disc 100 rotates at low speeds, which are defined herein as being no greater than 600 RPM, and typically as low as 40 RPM, optical or other types of encoders are needed, and the encoder spokes 204 have to be present on the optical disc 100. Embodiments of the present disclosure thus eliminate the need for such dedicated optical encoders to be added to optical disc devices to positionally control the optical disc 100 at low speeds, by leveraging the sensors 506C that are already present within such optical devices to positionally control the optical disc 100 at high speeds, to also positionally control the optical disc 100 at low speeds. As such, embodiments of the present disclosure eliminate the need for actual, physical encoder spokes being present within the optical disc 100.

The device 500 further includes a sled 508A, a sled motor 508B, and a rail 508D, which are collectively referred to as the second motor mechanism 508. As controlled by the controller 510, this motor mechanism 508 is that which permits positioning control of the sled 508A, and thus the optical mechanism 502, and therefore is that which determines the current radial position of the optical mechanism 502 incident to the optical disc 100. In some embodiments of the present disclosure, one or more additional components may be included, such as specifically a linear encoder to provide feedback for positioning control.

The optical mechanism 502 focuses an optical beam 504 on the optical disc 100. Specifically, the beam source 502A generates the optical beam 504, which is focused through the objective lens 502B onto the optical disc 100. The first motor mechanism 506 rotates the optical disc 100. Specifically, the optical disc 100 is situated on the spindle 506A, which is rotated, or moved, by the spindle motor 506B to a given position detected by the sensors 506C communicatively coupled to the spindle motor 506B.

The second motor mechanism 508 moves the optical mechanism 502 radially relative to the optical disc 100. Specifically, the optical mechanism 502 is situated on the sled 508A, which is moved on the rail 508D by the sled motor 508B to a given position specified by controller 510. To positionally control the second motor mechanism 508, the controller 501 may employ a linear encoder, other hardware, software, or a combination of hardware and software. The optical disc device 500 further includes a controller 510. The controller 510 selects positions on the optical disc 100 at which the optical beam 504 is to be focused for optically writing to and/or optically reading from such positions, by controlling the optical mechanism 502 as well as the first motor mechanism 506 and the second motor mechanism 508. The controller 510 is able to control the beam 504 generated by the beam source 502A, the focusing of the beam 504 through the objective lens 502B, the spindle motor mechanism 506B, and the sled motor 508B. The controller 510 may include hardware, software, or a combination of hardware and software. In one embodiment, the controller 510 may be or include firmware, as can be appreciated by those of ordinary skill within the art.

The controller 510 specifically positionally controls the optical disc 100 as the optical disc rotates at no more than 600 RPM (i.e., at low speeds) to permit the optical mechanism 502 to form a desired human-readable or other image on the optically writable label surface 104 of the optical disc 100. Positionally controls herein means that, for instance, the angular position and/or the angular speed of the optical disc as it rotates is controlled. The controller 510 positionally controls the optical disc 100 at these low speeds based on virtual spoke signals. The controller 510 generates the virtual spoke signals based on input signals received from the sensors 506C, as is described in more detail later in the detailed description.

These virtual spoke signals correspond to actual, physical spokes 204 that would otherwise have to be present on the optical disc 100 for the controller 510 to positionally control the optical disc 100 at speeds no greater than 600 RPM. However, the virtual spoke signals are virtual in that they do not correspond to actual, physical spokes 204 being detected. Rather, the virtual spoke signals are virtual in that they correspond to actual, physical spokes 204 that would otherwise have to be detected but for the generation of the virtual spoke signals.

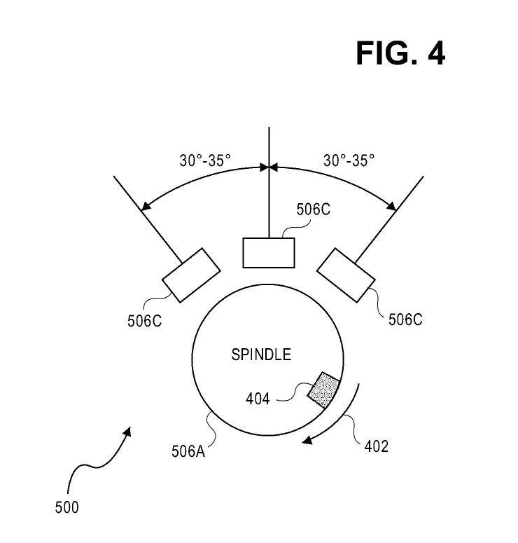

FIG. 4 shows top view of a portion of the optical disc device 500, according to an embodiment of the present disclosure. Specifically, the spindle 506A and the sensors 506C are depicted in FIG. 4. The spindle 506A is rotated, as indicated by the arrow 402 in FIG. 4, such as by the spindle motor 506B of FIG. 3. There are three of the sensors 506C in the embodiment of FIG. 4, although in other embodiments, there may be more or less of the sensors 506C. The sensors 506C are specifically Hall effect sensors in the embodiment of FIG. 4.

The spindle 506A, or alternatively the spindle motor 506B, includes one or more magnetic regions 404 therewithin or thereon, where one such region 404 is specifically depicted in FIG. 4. As the magnetic regions 404 rotate past the sensors 506C, the sensors 506C generate signals that are referred to herein as input signals. As such, the sensors 506C can be said to be responsive to rotation of the spindle 506A, and thus responsive to rotation of the optical disc 100 placed thereon. The sensors 506C can be particularly positioned around the spindle 506A (or around the spindle motor 506B) so that the input signals output by the sensors 506C are 120 degrees out of phase from one another. In one embodiment, this means that adjacent sensors 506C are positioned 30-to-35 degrees away from one another, as is specifically depicted in FIG. 4.

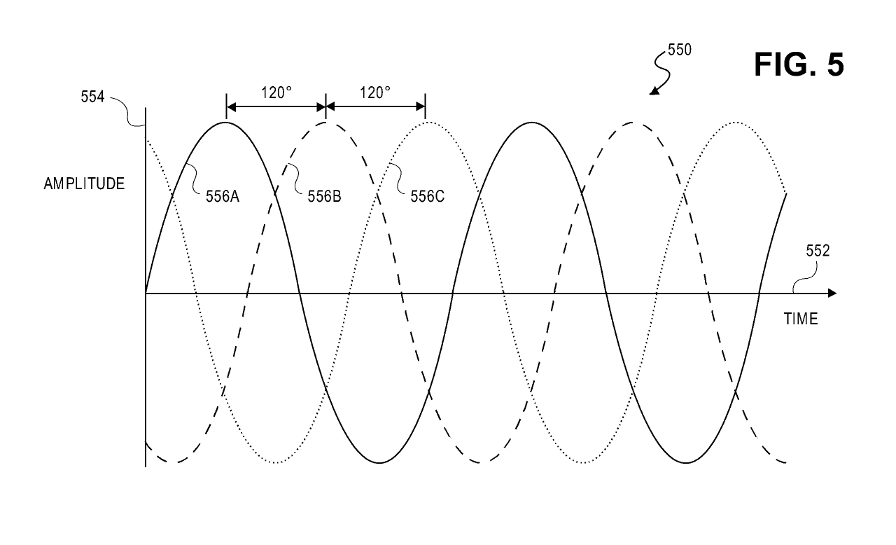

FIG. 5 shows a plot 550 of input signals 556A, 556B, and 556C, collectively referred to as the input signals 556, generated by the three Hall effect sensors 506C of FIG. 4, according to an embodiment of the present disclosure. The input signals 556 are plotted as having an amplitude indicated on the y-axis 554 of the plot 550 as a function of time indicated on the x-axis 552 of the plot 550. The input signal 556A is indicated by a solid line, the input signal 556B is indicated by a dashed line, and the input signal is indicated by a dotted line in FIG. 5 for illustrative clarity and differentiation.

As depicted in FIG. 5, adjacent input signals 556 generated by the Hall effect sensors 506C of FIG. 4 are 120 degrees out of phase from one another. Each of the input signals 556 can be said to have two components: an amplitude component, corresponding to the value of the input signal in question against the y-axis 554, and a phase component. The phase component of an input signal is based on the value of the input signal in question in relation to the x-axis 552.

For example, when an input signal crosses the x-axis 552 from a negative amplitude value to a positive amplitude value, it can be said to have a phase component of zero degrees. Thereafter, when the input signal reaches a maximum amplitude value, it can be said to have a phase component of 90 degrees, and when it thereafter crosses the x-axis 552 from a positive amplitude value to a negative amplitude value, the input signal can be said to have a phase component of 180 degrees. When the input signal reaches a minimum amplitude value, it can be said to have a phase component of 270 degrees.

Thus, in one complete revolution of the spindle 506A in FIG. 4, each of the input signals 556 spans one or more integer multiples of 360 degrees, corresponding to the number of magnetic regions on the spindle motor rotor. However, as has been noted, the input signals 556 themselves are 120 degrees out of phase. This can easily be seen in FIG. 5 in that adjacent input signals reach the maximum amplitude value 120 degrees apart.

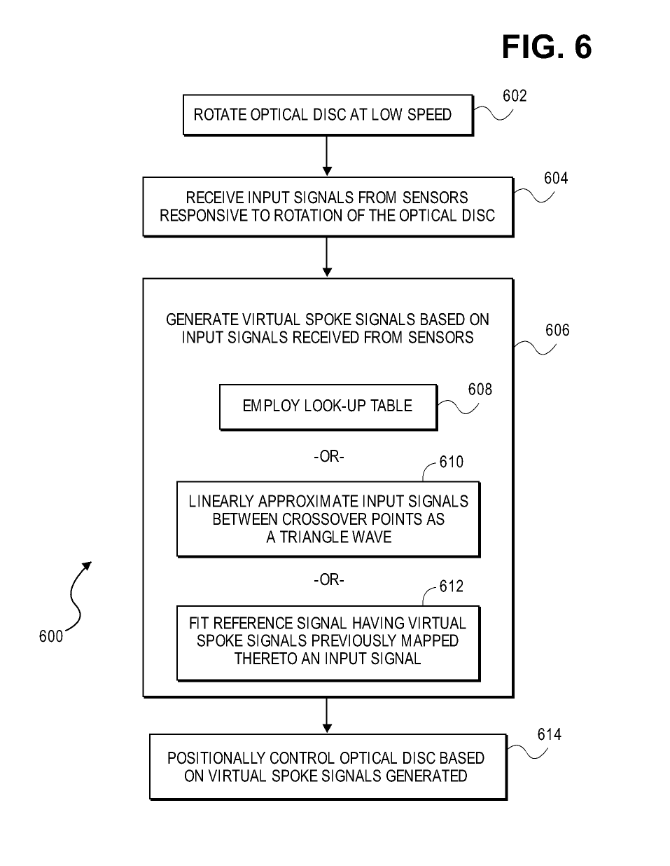

FIG. 6 shows a method 600 for positionally controlling the optical disc 100 as it rotates at low speeds, according to an embodiment of the present disclosure. The method 600 may be performed by the controller 510 in one embodiment. The method 600 may be implemented in the optical disc device hardware, or as one or more computer programs stored on a computer-readable medium and that may be executed by a processor, for instance. Such a computer-readable medium may be a recordable data storage, medium, firmware, or another type of computer-readable medium.

The optical disc 100 is rotated at low speed (602), such as no more than 600 RPM. The optical disc 100 may be rotated at such low speed so that the optical mechanism 502 can optically write a human-readable or other image to the optically writable label surface 104 of the optical disc 100. The optical disc 100 may be rotated by the controller 510 appropriately controlling the spindle motor 506B to which the spindle 506A is connected, where the optical disc 100 has been placed on the spindle 506A. The sensors 506C are used to positionally control the optical disc 100 in relation to the optical mechanism 502, as is described later in relation to FIG. 6.

The input signals 556 are received from the sensors 506C (604). The input signals 556 may be received directly in analog form by the controller 510. Alternatively, the input signals 556 may first be converted from analog form to digital form by an analog-to-digital converter (ADC) prior to being received by the controller 510.

Based on the input signals 556 received from the sensors 506, virtual spoke signals are generated (606). As has been noted, the virtual spoke signals correspond to actual, physical encoder spokes that would otherwise have to be present on the optical disc 100 for the optical disc 100 to be positionally controlled as the disc 100 rotates at low speed. Thus, the encoder spokes do not have to be present on the optical disc 100. In one embodiment, generating the virtual spoke signals based on the input signals 556 is achieved by performing part 608, part 610, or part 612 of the method 600.

First, a look-up table may be employed to generate the virtual spoke signals based on the input signals 556 (608). In particular, the amplitude components and the phase components of the input signals 556 are looked up against a previously generated look-up table, where this look-up table maps the amplitude components and the phase components of the input signals 556 to virtual spoke signals. Thus, when the amplitude components and the phase components of the input signals 556 have values corresponding to an entry within the look-up table, a corresponding virtual spoke signal may be generated or triggered in one embodiment. There may be 400 entries within the look-up table, corresponding to 400 virtual spokes numbered 1 through 400 that can be triggered based on the values of the amplitude and the phase components of the input signals 556.

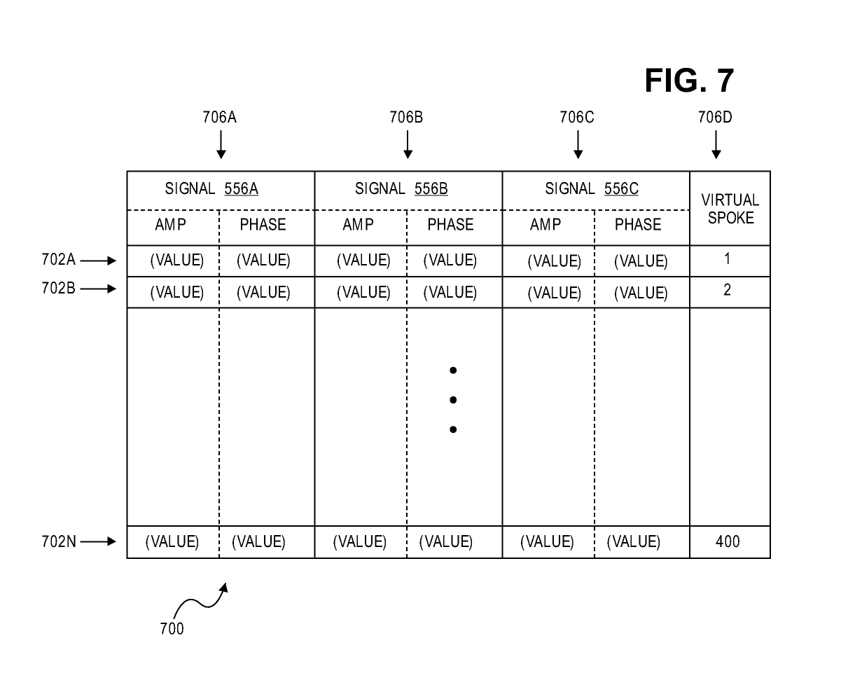

FIG. 7 shows a look-up table 700 that can be used to generate the virtual spoke signals based on the input signals 556, according to an embodiment of the disclosure. The look-up table 700 has a number of entries 702A, 702B, . . . 702N, collectively referred to as the entries 702. The entries 702 are organized over four columns 706A, 706B, 706C, and 706D, collectively referred to as the columns 706. The columns 706A, 706B, and 706C correspond to the signals 556A, 556B, and 556C, and are each divided into two sub-columns, an amplitude value sub-column and a phase value sub-column. The column 706D specifies virtual spoke number. In an embodiment where there are 400 virtual spokes, therefore, there are 400 entries 702.

When the controller 510 receives the amplitude and the phase components for the signals 556, it matches the values of these components against the corresponding values present in the columns 706A, 706B, and 706C. When a corresponding set of values is located within a given entry of the look-up table 700, the controller 510 determines the virtual spoke number specified in that entry. In this way, the look-up table 700 is employed to generate virtual spoke signals based on the input signals 556.

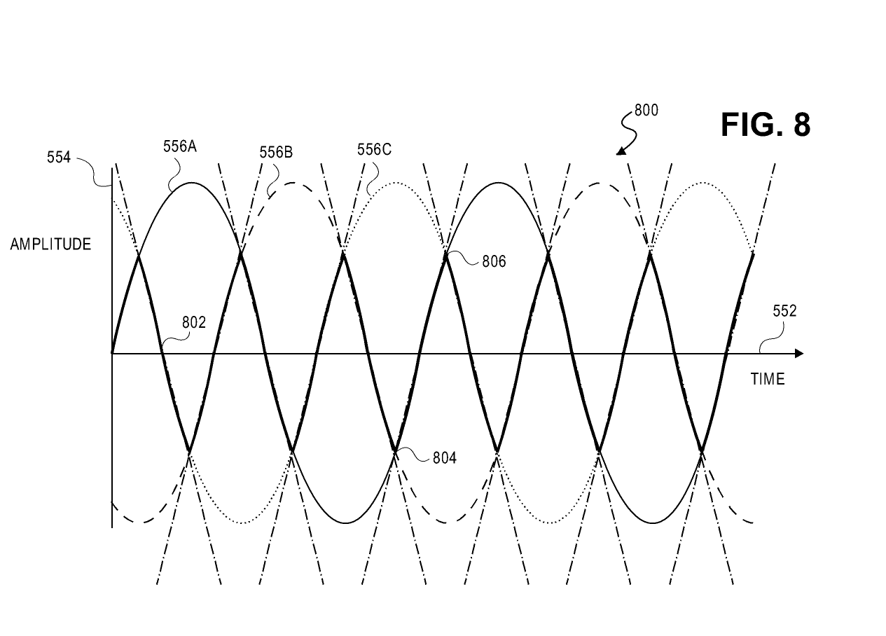

Referring back to FIG. 6, the input signals 556 may alternatively be linearly approximated between crossover points as a triangle wave to generate the virtual spoke signals based on the input signals (610). FIG. 8 shows a plot 800 of the input signals 556 in which a triangle wave linearly approximates the input signals 556 between crossover points, according to an embodiment of the present disclosure. The plot 800 has the x-axis 552 and the y-axis 554 denoting time and amplitude, respectively, as in the plot 550 of FIG. 5. The crossover points are defined as the points at which any two of the input signals 556 intersect, or cross, one another. The crossover points thus include the crossover points 804 and 806 that are specifically called out in FIG. 8 for example purposes.

Based on this triangle wave linear approximation of the input signals 556, a function can be developed that specifies a virtual spoke number as function of the slope of the triangle wave, as well as a function of time, as can be appreciated by those of ordinary skill within the art. The function can be expressed in the form spoke_number=f(slope, time), and can return an integer between 1 and 400 (or another maximum virtual spoke number) as the virtual spoke. It is noted that as the optical disc 100 is rotated more quickly, the absolute value of the slope of the triangle wave increases. By comparison, as the optical disc 100 is rotated more slowly, the absolute value of the slope of the triangle wave decreases. In this way, the slope of the triangle wave controls how quickly or how slowly successive virtual spokes are generated.

Furthermore, the function is cyclical for a given period of the input signals 556. The period of an input signal is the length of time it takes to reach the same point within the input signal where the input signal is either increasing at both the beginning and the end of the period, or decreasing at both the beginning and the end of the period. Thus, the virtual spoke numbers are counted from 1 to 400 (or another maximum virtual spoke number) within each period. In this way, the triangle wave linear approximation of the input signals 556 between crossover points can be employed to generate the virtual spoke signals.

Referring back to FIG. 6, the virtual spoke signals may be generated by fitting a reference signal to one of the input signals 556 (612). The reference signal has previously or a priori mapped thereto the desired number of virtual spokes (i.e., the virtual spoke signals). The reference signal is expanded or contracted to correspond to the selected input signal 556. Based on this fitting or the matching of the reference signal to the selected input signal 556, the virtual spoke signals can be generated based on where the virtual spokes are located in relation to the reference signal, where these virtual spokes expand and contract in their location along with the reference signal itself. In this way, the virtual spoke signals can be generated from the input signals 556.

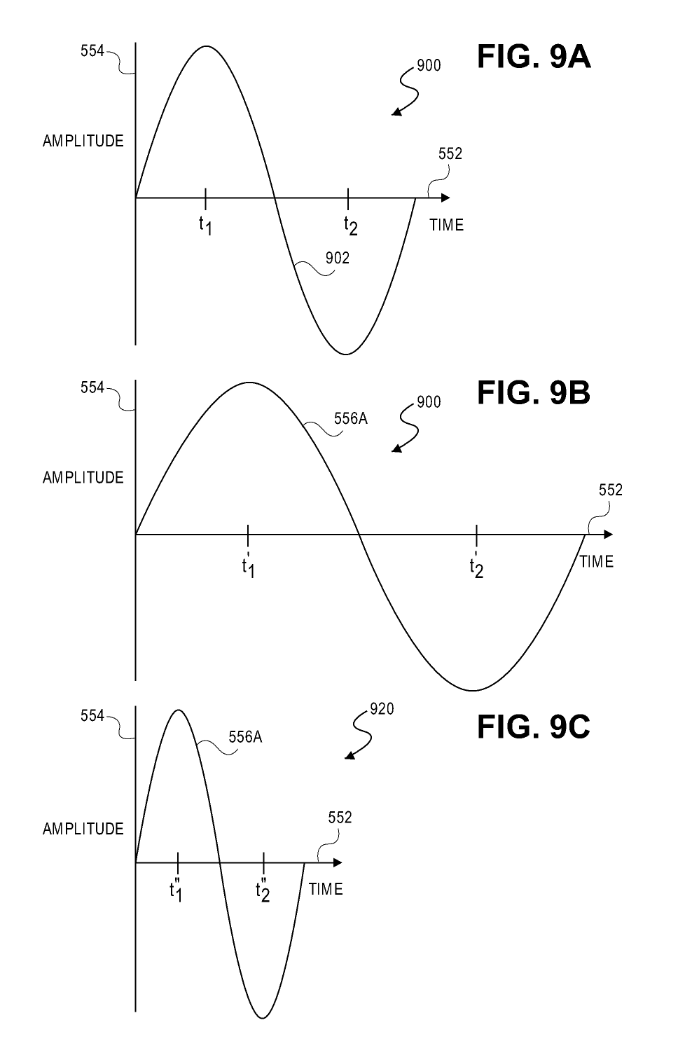

FIGS. 9A, 9B, and 9C exemplarily illustrate how a reference signal can be fitted to one of the input signals 556 to generate the virtual spoke signals, according to an embodiment of the present disclosure. In FIG. 9A, a plot 900 of a reference signal 902 is depicted against the x-axis 552 denoting time and the y-axis 554 denoting amplitude. It is a priori determined or otherwise known that the virtual spokes occur at various times along the period of the reference signal 902, where FIG. 9A shows one such period of the signal 902. For example purposes, two virtual spoke trigger points are indicated in FIG. 9A, at times t₁ and t₂. Thus, at time t₁ a given virtual spoke number is generated, and at time t₂ a different virtual spoke number is generated.

In FIG. 9B, an example plot 910 of an actual input signal 556A that has been received is depicted against the x-axis 552 denoting time and the y-axis 554 denoting amplitude. The actual input signal 556A is depicted in FIG. 9B such that the optical disc 100 is being rotated more slowly than the reference signal 900 indicates in FIG. 9A. Therefore, the reference signal 900 is fitted to the actual input signal 556A. In FIG. 9B, this means that the reference signal 900 is effectively expanded, or stretched, so that the reference signal 900 coincides with and overlaps the actual input signal 556A. The locations at which the virtual spokes are triggered in the reference signal 900 are correspondingly stretched or expanded proportionally. Thus, rather than the given virtual spoke number being generated at time t₁ as in FIG. 9A, it is generated at time t₁′, where t₁′ occurs after t₁. Likewise, rather than the other given virtual spoke number being generated at time t₂ as in FIG. 9A, it is generated at time t₂′, where t₂′ occurs after t₂.

In FIG. 9C, another example plot 920 of the actual input signal 556A that has been received is depicted against the x-axis 552 denoting time and the y-axis 554 denoting amplitude. The actual input signal 556A is depicted in FIG. 9C such that the optical disc 100 is being rotated more quickly than the reference signal 900 indicates in FIG. 9A. Therefore, the reference signal 900 is again fitted to the actual input signal 556A. In FIG. 9C, this means that the reference signal 900 is effectively compressed, or contracted, so that the reference signal 900 coincides with and overlaps the actual input signal 556A. The locations at which the virtual spokes are triggered in the reference signal 900 are correspondingly compressed or contracted proportionally. Thus, rather than the given virtual spoke number being generated at time t₁ as in FIG. 9A, it is generated at time t₁″, where t₁″ occurs before t₁. Likewise, rather than the other given virtual spoke number being generated at time t₂ in FIG. 9A, it is generated at time t₂″, where t₂″ occurs before t₂.

Referring back to FIG. 6, once the virtual spoke signals have been generated in part 606, the controller 510 is able to positionally control the optical disc 100 based on these virtual spoke signals (614). Such positional control of the optical disc 100 can be achieved in the same way that it is achieved when actual, physical spokes formed on the optical disc 100 are detected, as can be appreciated by those of ordinary skill within the art. Thus, at least some embodiments can be considered as “drop in” replacements within methodologies that positionally controlled optical discs on the basis of detecting actual, physical spokes on the optical discs.

That is, rather than having to detect such encoder spokes, such methodologies can now use the virtual spoke signals that are inventively generated as has been described. As such, encoders and other components that had been included within optical disc devices solely for the purpose of detecting actual, physical encoder spokes no longer need to be included, and encoder spokes that had been formed on the optical discs no longer need to be added to the optical discs. In both of these ways, embodiments of the present disclosure provide for cost savings over the prior art.

It is noted that the method 600 may include other parts, in addition to and/or in lieu of those particularly depicted in FIG. 6. For example, as the optical disc 100 is being positionally controlled on the basis of the virtual spoke signals that have been generated, the optical mechanism 502 may be employed to optically write a desired image to the optically writable label surface 104 of the optical disc 100. The optical disc 100 thus may be positionally controlled at the low speeds that may be needed for such optical writing to the label surface 504 to occur, by novelly using the sensors 506C that heretofore could not be used for such positional control of the optical disc 100 at these low speeds.

We claim:

1. A method (600) comprising:
rotating an optical disc at no more than 600 revolutions per minute (RPM), using a spindle motor of an optical disc device (602);
receiving one or more input signals from one or more sensors disposed within the optical disc device, the sensors responsive to rotation of the optical disc (604);
generating a plurality of virtual spoke signals based on the input signals received from the sensors (606); and,
positionally controlling the optical disc based on the virtual spoke signals generated, as the optical disc rotates at no more than 600 RPM (614),
wherein the virtual spoke signals correspond to actual, physical spokes that would otherwise have to be present on the optical disc to positionally control the optical disc.

2. The method of claim 1, wherein generating the virtual spoke signals eliminates a need for the actual, physical spokes being present on the optical disc.

3. The method of claim 1, wherein generating the virtual spoke signals based on the input signals received from the sensors eliminates a need for the optical disc device to include an encoder to detect actual, physical spokes on the optical disc.

4. The method of claim 1, wherein the sensors are ordinarily and normally disposed within the optical disc device to control the optical disc as the optical disc rotates at no less than 800 RPM.

5. The method of claim 1, wherein receiving the input signals from the sensors comprises receiving from each sensor an input signal having an amplitude component and a phase component.

6. The method of claim 5, wherein generating the virtual spoke signals based on the input signals received from the sensors comprises looking up the amplitude components and the phase components of the input signals against a previously generated look-up table, the look-up table mapping the amplitude components and the phase components of the input signals to the virtual spoke signals (608).

7. The method of claim 5, wherein generating the virtual spoke signals based on the input signals received from the sensors comprises linearly approximating the input signals between crossover points as a triangle wave, such that the virtual spoke signals are generated based at least on a slope of the triangle wave (610).

8. The method of claim 5, wherein generating the virtual spoke signals based on the input signals received from the sensors comprises fitting a reference signal having virtual spoke signals previously mapped thereto to one of the input signals, such that the virtual spoke signals are generated based on the one of the input signals tracking the reference signal as fitted thereto (612).

9. An optical disc device (500) comprising:
a spindle motor to rotate an optical disc at least at speeds no more than 600 revolutions per minute (RPM) (506B);
an optical mechanism to form an image on an optically writable label surface of the optical disc as the optical disc rotates at no more than 600 RPM (502);
one or more sensors responsive to rotation of the optical disc (506C); and,
a controller to positionally control the optical disc as the optical disc rotates at no more than 600 RPM to permit the optical mechanism to form the image on the optically writable label surface of the optical disc (510),
wherein the controller positionally controls the optical disc based on a plurality of virtual spoke signals, the controller generating the virtual spoke signals based on input signals received from the sensors, and
wherein the virtual spoke signals correspond to a predetermined pattern of actual, physical spokes that would otherwise have to be present on the optical disc to positionally control the optical disc.

10. The optical disc device of claim 9, wherein the controller generating the virtual spoke signals eliminates a need for the actual, physical spokes being present on the optical disc.
